(19) United States
(12) Patent Application Publication
(10) Pub. No.: US 2008/0315462 A1
(43) Pub. Date: Dec. 25, 2008

(54) SYSTEMS AND METHODS FOR MONITORING A COMPOSITE CURE CYCLE

(75) Inventors: Thomas James Batzinger, Burnt Hills, NY (US); Andrzej May, Schenectady, NY (US); James Norman Barshinger, Scotia, NY (US); Scott Roger Finn, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/767,667

(22) Filed: Jun. 25, 2007

(51) Int. Cl. G01B 17/02

(52) U.S. Cl. 264/407; 425/141

(57) ABSTRACT

A system for monitoring at least one of a resin infusion process and a composite cure cycle of a composite article is provided. The system includes an ultrasonic transmitter configured to deliver an acoustic wave to a resin-infused fiber preform and an ultrasonic receiver configured to receive the acoustic wave propagated through the resin-infused fiber preform. The system also includes a processor configured to estimate at least one parameter using the received acoustic wave and to use the at least one parameter to determine an extent to which at least one resin has infused into the resin-infused fiber preform.

### BACKGROUND

The invention relates generally to monitoring methods for use during manufacturing processes of composite articles and, more particularly to, methods for monitoring resin infusion processes and composite cure cycles of resin-infused composite articles.

Various types of manufacturing processes are known for manufacturing composite articles. For example, resin pumping or vacuum infusion processes may be employed to manufacture a composite article by infusion of one or more resins into a fiber preform. Monitoring of such manufacturing processes is desirable to facilitate final component quality. For example, it is desirable to monitor the cure cycle of the composite and to ensure that the resin is completely infused into the component and that there is no resin pooling. Further, it is desirable to adjust process parameters of the manufacturing process based upon the state of the composite article during the curing cycle.

Certain manufacturing systems employ thermocouples to monitor a temperature of the composite article during the composite cure cycle. Further, the heating of the composite article is controlled based upon the measured temperature. However, such technique is an indirect assessment of the composite quality and does not provide adequate measurement of parameters related to the composite cure cycle.

Accordingly, it would be desirable to develop monitoring techniques that provide direct assessment of quality of a composite article during the composite manufacturing process. Furthermore, it would be desirable to provide a method for monitoring the resin infusion process and composite cure cycle of composites for assessing the quality of the composite.

### BRIEF DESCRIPTION

Briefly, according to one embodiment of the invention, a system for monitoring at least one of a resin infusion process and a composite cure cycle of a composite article is provided. The system includes an ultrasonic transmitter configured to deliver an acoustic wave to a resin-infused fiber preform and an ultrasonic receiver configured to receive the acoustic wave propagated through the resin-infused fiber preform. The system also includes a processor configured to estimate at least one parameter using the received acoustic wave and to use the at least one parameter to determine an extent to which at least one resin has infused into the resin-infused fiber preform.

In another embodiment, a system for monitoring at least one of a resin infusion process and a composite cure cycle of a composite article is provided. The system includes an electromagnetic sensor configured to measure a distance between the electromagnetic sensor and a mold supporting a resin-infused fiber preform. The system includes an ultrasonic transmitter configured to deliver an acoustic wave to the resin-infused fiber preform and an ultrasonic receiver configured to receive the acoustic wave propagated through the resin-infused fiber preform. The system also includes a processor configured to estimate at least one parameter from the measured distance and to use the received acoustic wave to determine an extent to which at least one resin has infused into the resin-infused fiber preform.

In another embodiment, a method for monitoring at least one of a resin infusion process and a composite cure cycle of a composite article is provided. The method includes delivering an acoustic wave to a resin-infused fiber preform of the composite and receiving an acoustic wave propagated through the resin-infused fiber preform. The method also includes estimating at least one parameter using the received acoustic wave and using the at least one parameter to determine an extent to which at least one resin has infused into the resin-infused fiber preform.

In another embodiment, a method for monitoring at least one of a resin infusion process and a composite cure cycle of a composite article is provided. The method includes measuring a distance between a mold supporting a resin-infused fiber preform and an electromagnetic sensor using the electromagnetic sensor, delivering an acoustic wave to the resin-infused fiber preform of the composite article and receiving an acoustic wave propagated through the resin-infused fiber preform. The method also includes estimating at least one parameter using the received acoustic wave and the measured distance and using the at least one parameter to determine an extent to which at least one resin has infused into the resin-infused fiber preform.

In another embodiment, a system for manufacturing a composite article is provided. The system includes a mold for receiving a fiber preform, a vacuum bag for applying pressure to the fiber preform during a resin infusion process to facilitate infusion of at least one resin into the fiber preform and an electromagnetic sensor coupled to the vacuum bag and configured to measure a distance between the electromagnetic sensor and the mold. The system also includes an ultrasonic transmitter coupled to the mold and configured to deliver an acoustic wave to the resin-infused fiber preform, an ultrasonic receiver coupled to the vacuum bag and configured to receive the acoustic wave propagated through the resin-infused fiber preform and a processor. The processor is configured to estimate at least one parameter from the measured distance, use the received acoustic wave to determine an extent to which the at least one resin has infused into the resin-infused fiber preform and control at least one operating parameter of the composite cure cycle based upon the at least one parameter.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of an exemplary composite manufacturing system for manufacturing a composite article.

FIG. 2 is a diagrammatical representation of an exemplary set up of the manufacturing system of FIG. 1 where the resin has completely infused into a fiber preform.

FIG. 3 is a graphical representation of an exemplary acoustic velocity profile for the composite cure cycle of the composite article of FIG. 2.

FIG. 4 is a diagrammatical representation of an exemplary set up of the manufacturing system of FIG. 1 with partial resin infusion into the fiber preform and having resin pooling.

FIG. 5 is a diagrammatical representation of an exemplary set up of the manufacturing system of FIG. 1 with no resin infusion into the fiber preform and having resin pooling.

FIG. 6 is a diagrammatical illustration of an exemplary configuration of the electromagnetic sensor employed in the composite manufacturing system of FIG. 1

### DETAILED DESCRIPTION

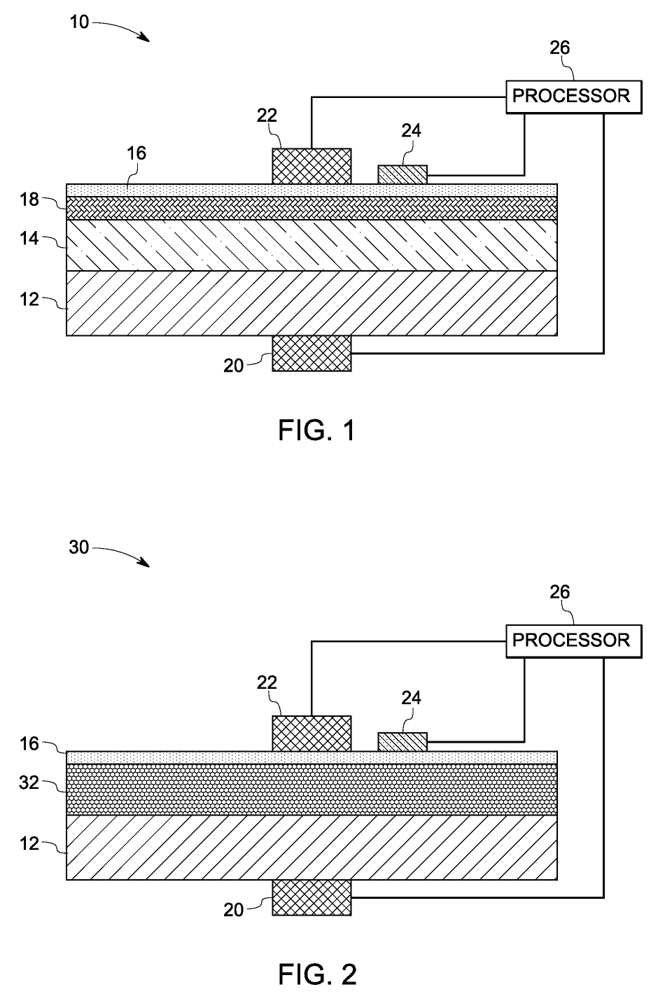

As discussed in detail below, embodiments of the present invention function to provide monitoring methods for manufacturing processes of composite articles. In particular, the present invention provides monitoring techniques for monitoring resin infusion process and composite cure cycle of resin-infused composite articles. Referring now to the drawings, FIG. 1 illustrates an exemplary composite manufacturing system 10 for manufacturing a composite article. In the illustrated embodiment, the manufacturing system 10 includes a mold 12 for receiving a fiber preform 14. Fiber preforms 14 typically comprise fabric architecture including a plurality of fibers. The fibers may be continuous or non-continuous fibers. Examples of fiber materials include, but are not limited to, carbon, glass, polyimide, polyethylene, polypyridobisimidazole, boron, p-phenylenetherephtalamide, ceramic, aromatic polyamide, and silicon carbide.

In certain exemplary embodiments, the mold 12 includes steel, or aluminum, or a composite. However, other suitable materials may be employed for the mold 12. The shape, size and configuration of the mold may depend in part on the shape and size of the composite article to be manufactured. Molds and associated parts are well known in the art and are not described in detail herein. Further, the manufacturing system 10 includes a vacuum bag 16 for applying pressure to the fiber preform 14 during a resin infusion process to facilitate infusion of at least one resin such as represented by reference numeral 18 into the fiber preform 14. In one embodiment, the resin includes epoxy resin. However, a variety of other resins may be used for manufacturing the composite article, non-limiting examples of which include a polyester, a vinylester, a phenolic resin, an acrylic resin, polyurethane resin, a bismaleimide, a polyamide, a polyimide, and a dicyclopentadiene, ceramics and other curable liquid resins.

In operation, the pressure inside the vacuum bag 16 is reduced causing the external atmospheric pressure to exert force on the vacuum bag 16. This pressure removes entrapped air, excess resin, and compacts the fiber preform 14 to form a resin-infused fiber preform or composite article as shown in FIG. 2. During a composite cure cycle of the composite article, the article is placed under a combination of temperature and pressure conditions that is designed to achieve desired matrix solidification. Typically, the composite cure cycle starts with compressing packets of the resin 18 or by pumping of the resin 18 through the fiber preform 14, or through vacuum suction of the resin 18 into the fiber preform 14 to infuse the resin 18 into the fiber preform 14 as the matrix material.

In the illustrated embodiment, the manufacturing system 10 includes an ultrasonic transmitter 20, an ultrasonic receiver 22 and an electromagnetic sensor 24 configured to monitor at least one of the resin infusion process and the composite cure cycle of the composite article. Further, the manufacturing system 10 includes a processor 26 configured to estimate at least one parameter to determine an extent to which the at least one resin 18 has infused into the fiber preform 14. In certain embodiments, the processor is configured to control at least one operating parameter of the composite cure cycle based upon the at least one parameter. It should be noted that the present invention is not limited to any particular processor for performing the processing tasks of the invention. The term “processor,” as that term is used herein, is intended to denote any machine capable of performing the calculations, or computations, necessary to perform the tasks of the invention. The term “processor” is intended to denote any machine that is capable of accepting a structured input and of processing the input in accordance with prescribed rules to produce an output. It should also be noted that the phrase “configured to” as used herein means that the processor is equipped with a combination of hardware and software for performing the tasks of the invention, as will be understood by those skilled in the art. The monitoring of the resin infusion process and the composite cure cycle will be described in detail below with reference to FIG. 2.

FIG. 2 is a diagrammatical representation of an exemplary set up 30 of the manufacturing system 10 of FIG. 1 where the resin 18 has completely infused into the fiber preform 14 to form a resin-infused preform 32. As illustrated, the manufacturing system 30 includes the ultrasonic transmitter 22 coupled to the mold 12 and configured to deliver an acoustic wave to the resin-infused fiber preform 32. Further, the manufacturing system 30 includes an ultrasonic receiver 22 coupled to the mold 16 and configured to receive the acoustic wave propagated through the resin-infused preform 32. As described above, the composite cure cycle starts with compressing packets of the resin 18 or by pumping of the resin 18 through the fiber preform 14, or through vacuum suction of the resin 18 into the fiber preform 14 to infuse the resin 18 into the fiber preform 14 as the matrix material. It should be noted that once the resin 18 has infused into the fiber preform 14 then the acoustic wave can travel through the resin-infused fiber preform 32 and may be used to determine a degree of composite cure of the composite article 32.

The processor 26 is coupled to the ultrasonic transmitter 20 and the ultrasonic receiver 22 and is configured to estimate at least one parameter using the received acoustic wave. Examples of the at least one parameter include a transmission attenuation of the acoustic wave, time-of-flight (TOF) of the acoustic wave, and so forth. In this exemplary embodiment, the processor 26 is configured to estimate an acoustic velocity of the acoustic wave using the time-of-flight. In one exemplary embodiment, the processor 26 is configured to determine a degree of composite cure based upon the acoustic velocity of the acoustic wave. The acoustic velocity measurement provides an indication of the viscosity of the resin 18 during different stages of the composite cure cycle thereby providing a measure of the degree of composite cure. In certain embodiments, the manufacturing system 30 may include a plurality of ultrasonic transmitters 20 and ultrasonic receivers 22 disposed at a plurality of locations for monitoring at least one of the resin infusion process and the composite cure cycle at the plurality of locations.

In this exemplary embodiment, the manufacturing system 30 also includes the electromagnetic sensor 20 configured to measure a distance between the electromagnetic sensor 20 and the mold 12. In particular, an amplitude and a signal phase angle of the signal from the electromagnetic sensor 20 are utilized to measure the distance between the electromagnetic sensor 20 and the mold 12. In certain embodiments, an operating frequency of the electromagnetic sensor 20 may be adjusted to provide a measurement of a gap between the electromagnetic sensor 20 and the mold 12. In one exemplary embodiment, the electromagnetic sensor 20 is coupled to the vacuum bag 16. Moreover, the processor 26 is configured to estimate a thickness of the composite article 32 based upon the measured distance between the electromagnetic sensor 20 and the fiber preform 14. In an exemplary embodiment, the electromagnetic sensor 20 includes an eddy current sensor. Further, the eddy current sensor 20 may include at least one coil wherein the coil functions as a thermocouple that is configured to monitor temperature of the composite article during the composite cure cycle.

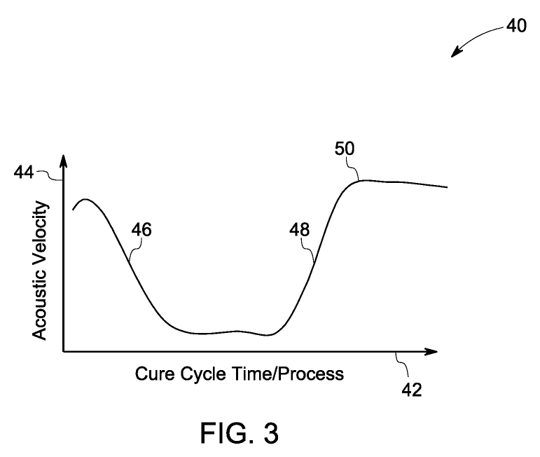

As described above, the processor 26 is configured to determine a degree of composite cure based upon the acoustic velocity of the acoustic wave received from the ultrasonic receiver 22. FIG. 3 is a graphical representation of an exemplary acoustic velocity profile 40 for the composite cure cycle of the composite article 32 of FIG. 2. In this exemplary embodiment, the abscissa axis represents a cure cycle time 42 and the ordinate axis represents the acoustic velocity 44 of the acoustic wave received by the ultrasonic receiver 22 (see FIG. 2). As illustrated, the composite article 32 undergoes changes its state as it undergoes the cure cycle that is measured by the change in the acoustic velocity 44. For example, the acoustic velocity 44 decreases during the initial infusion of the resin 18 (see FIG. 2) into the fiber preform 14 (see FIG. 2) due to the reduction in the viscosity of the resin 18, as represented by exemplary profile 46.

Further, during the polymer resin gelation and cure, the acoustic velocity increases due to the increase in the viscosity of the resin 18, which is represented by an exemplary profile 48. Once the cure cycle is completed, the acoustic velocity is almost constant and this state is represented by an exemplary profile 50. Thus, measuring the acoustic velocity 44 of the acoustic wave received by the ultrasonic receiver 22 facilitates real time monitoring of the degree of composite cure of the composite article 32.

In certain embodiments, the processor 26 (see FIG. 2) may facilitate a closed-loop control of operating parameters of the composite cure cycle based upon the degree of composite cure. Further, the processor 26 is configured to detect formation of resin pools in the composite article 32 using the electromagnetic sensor 20.

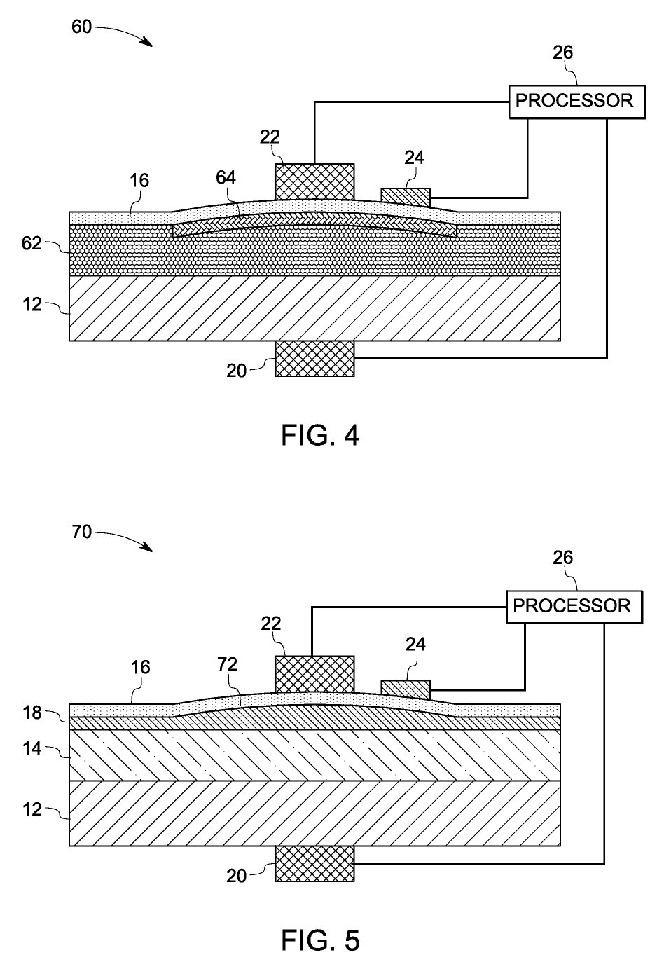

FIG. 4 is a diagrammatical representation of an exemplary set up 60 of the manufacturing system 10 of FIG. 1 with partial resin infusion into the fiber preform 14 and having resin pooling. In this embodiment, the resin 18 has partially infused into the fiber preform 14 to form the resin-infused preform 62. In addition, at certain locations, the resin 18 has pooled to form resin pools such as represented by reference numeral 64. In this exemplary embodiment, the processor 26 is configured to detect the presence of the resin pool 64 based upon the distance between the electromagnetic sensor 24 and the resin-infused preform 62. Again, the operating parameters of the composite cure cycle may be controlled to prevent the formation of the resin pools 64.

FIG. 5 is a diagrammatical representation of another exemplary set up of 70 of the manufacturing system 10 of FIG. 1 with no resin infusion into the fiber preform 14 and having resin pooling. As illustrated, the resin 18 has not infused into the fiber preform 14 and forms a resin pool 72 at the surface of the fiber preform 14. In this exemplary embodiment, the acoustic wave generated by the ultrasonic transmitter 20 is blocked at an interface of the mold 12 and the fiber preform 14 as indicating no resin infusion into the fiber preform 14. Furthermore, an increased measured distance between the vacuum bag 14 and the fiber preform 14 indicates the presence of the resin pool 72.

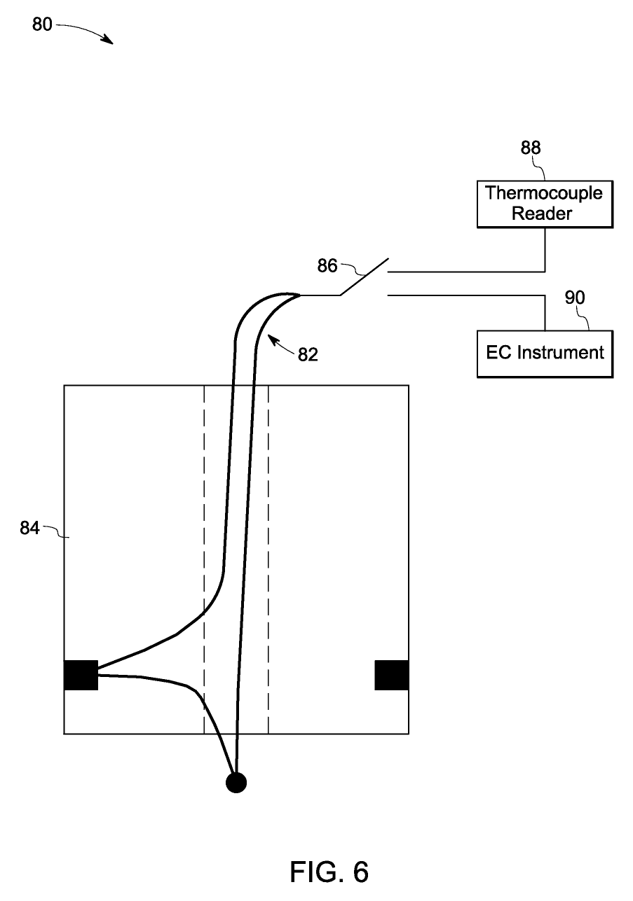

FIG. 6 is a diagrammatical illustration of an exemplary configuration 80 of the electromagnetic sensor 24 (which is indicated by reference numeral 24 in FIG. 1) employed in the composite manufacturing system 10 of FIG. 1. In the illustrated embodiment, the electromagnetic sensor 80 comprises an eddy current sensor. The sensor 80 includes a Constantine conductor 82 that is wound on a fiberglass form 84 to form a dual-purpose eddy current and thermocouple probe. In this embodiment, the probe 80 may be employed as a Type J thermocouple as well as a lift-off sensor. However, the probe 80 may be fabricated for other thermocouple materials such as Type K thermocouple. Further, the coil form could include other conductive materials such as ceramics, plastic, glass, wood and so forth. In certain embodiments, an operating frequency of the sensor 80 may be adjusted to provide a measurement of a gap between the sensor 80 and the mold 12 (see FIG. 1). In one exemplary embodiment, the operating frequency of the sensor 80 is about 700 kHz to measure thickness of the resin 18 (see FIG. 1) between the sensor 80 and the fiber preform 14 (see FIG. 1). Further, as described above, the sensor 80 functions as a thermocouple configured to monitor temperature of the composite article during the composite cure cycle.

In this exemplary embodiment, the signal from the probe 80 is directed to a thermocouple reader 88 and an eddy current instrument 90. Further, a switch 86 is employed to multiplex the probe 80 between the thermocouple reader 88 and the eddy current instrument 90. The thermocouple reader 88 measures the voltage from the sensor 80 for determining the temperature of the composite article. Further, the eddy current instrument 90 measures the eddy current from the sensor 80 for determining the distance between the sensor 80 and the mold 12. The combined eddy current/thermocouple probe 80 permits the use of a single thermocouple port on an autoclave to measure both temperature and resin pooling data. In general, the diameter of the probe should be at least as large as the distance to be measured between the probe and the composite or mold surface.

The methods and systems described above allow direct assessment of quality of composite articles during the composite manufacturing process. In particular, the present invention utilizes a combination of ultrasonic and electromagnetic signal monitoring techniques to facilitate monitoring of resin infusion process and composite cure cycle of the composite articles for assessing the quality of the composite articles. Advantageously, the assessment of the quality of the composite articles as described above may be used to control the operating parameters of the composite manufacturing system to ensure a quality final component.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system for monitoring at least one of a resin infusion process and a composite cure cycle of a composite article, the system comprising:
an ultrasonic transmitter configured to deliver an acoustic wave to a resin-infused fiber preform;
an ultrasonic receiver configured to receive the acoustic wave propagated through the resin-infused fiber preform; and
a processor configured to:
estimate at least one parameter using the received acoustic wave; and
use the at least one parameter to determine an extent to which at least one resin has infused into the resin-infused fiber preform.

2. The system of claim 1, wherein the ultrasonic transmitter is coupled to a mold supporting the fiber preform, and wherein the ultrasonic receiver is coupled to a vacuum bag configured to provide pressure to the fiber preform during the resin infusion process.

3. The system of claim 2, further comprising an electromagnetic sensor configured to measure at least one of a distance between the electromagnetic sensor and the mold, and a distance between the electromagnetic sensor and the resin-infused fiber preform.

4. The system of claim 3, wherein the processor is configured to estimate a thickness of the composite article based upon the measured distance between the electromagnetic sensor and the mold or between electromagnetic sensor and the resin-infused fiber preform.

5. The system of claim 3, wherein the electromagnetic sensor is coupled to the vacuum bag.

6. The system of claim 1, wherein the at least one parameter comprises a transmission attenuation of the acoustic wave, or a time-of-flight of the acoustic wave, or an acoustic velocity of the acoustic wave, or combinations thereof.

7. The system of claim 6, wherein the processor is further configured to determine a degree of composite cure based upon the acoustic velocity of the acoustic wave.

8. The system of claim 1, further comprising a plurality of ultrasonic transmitters and ultrasonic receivers disposed at a plurality of locations for monitoring at least one of the resin infusion process and the composite cure cycle at the plurality of locations.

9. A system for monitoring at least one of a resin infusion process and a composite cure cycle of a composite article, the system comprising:
an electromagnetic sensor configured to measure a distance between the electromagnetic sensor and a mold supporting a resin-infused fiber preform;
an ultrasonic transmitter configured to deliver an acoustic wave to the resin-infused fiber preform;
an ultrasonic receiver configured to receive the acoustic wave propagated through the resin-infused fiber preform; and
a processor configured to:
estimate at least one parameter from the measured distance between the electromagnetic sensor and the mold; and
use the received acoustic wave to determine an extent to which at least one resin has infused into the resin-infused fiber preform.

10. The system of claim 9, wherein the ultrasonic transmitter is coupled to the mold, and wherein the electromagnetic sensor and the ultrasonic receiver are coupled to a vacuum bag configured to provide pressure to the resin-infused fiber preform during the resin infusion process.

11. The system of claim 9, wherein the at least one parameter comprises a thickness of the composite, or a transmission attenuation of the acoustic wave, or a time-of-flight of the acoustic wave, or an acoustic velocity of the acoustic wave, or combinations thereof.

12. The system of claim 9, wherein the processor is further configured to determine a degree of composite cure based upon the acoustic velocity of the acoustic wave.

13. The system of claim 9, wherein the electromagnetic sensor comprises an eddy current sensor.

14. The system of claim 13, wherein the eddy current sensor comprises at least one coil, and wherein the coil functions as a thermocouple configured to monitor temperature of the composite article during the composite cure cycle.

15. The system of claim 14, further comprising a thermocouple reader and an eddy current instrument coupled to the sensor.

16. The system of claim 9, wherein the processor is further configured to detect formation of a resin pool in the composite article based upon the distance between the electromagnetic sensor and the mold.

17. A method for monitoring at least one of a resin infusion process and a composite cure cycle of a composite article, the method comprising:
delivering an acoustic wave to a resin-infused fiber preform of the composite;
receiving an acoustic wave propagated through the resin-infused fiber preform;
estimating at least one parameter using the received acoustic wave; and
using the at least one parameter to determine an extent to which at least one resin has infused into the resin-infused fiber preform.

18. The method of claim 17, wherein the at least one parameter comprises a transmission attenuation of the acoustic wave, or a time-of-flight of the acoustic wave, or an acoustic velocity of the acoustic wave, or combinations thereof

19. The method of claim 18, further comprising determining a degree of composite cure based upon the acoustic velocity of the acoustic wave.

20. The method of claim 17, further comprising controlling an operating parameter of the composite cure cycle based upon the at least one parameter.

21. A method for monitoring at least one of a resin infusion process and a composite cure cycle of a composite article, the method comprising:
measuring a distance between a mold supporting a resin-infused fiber preform and an electromagnetic sensor using the electromagnetic sensor;
delivering an acoustic wave to the resin-infused fiber preform of the composite article;
receiving an acoustic wave propagated through the resin-infused fiber preform;
estimating at least one parameter using the received acoustic wave and the measured distance; and
using the at least one parameter to determine an extent to which at least one resin has infused into the resin-infused fiber preform.

22. The method of claim 21, wherein the measuring step comprises determining a thickness of the composite during the composite cure cycle.

23. The method of claim 21, wherein the at least one parameter comprises a transmission attenuation of the acoustic wave, or a time-of-flight of the acoustic wave, or an acoustic velocity of the acoustic wave, or combinations thereof

24. The method of claim 23, further comprising determining a degree of composite cure based upon the acoustic velocity of the acoustic wave.

25. The method of claim 21, further comprising detecting formation of a resin pool in the composite article based upon the distance between the electromagnetic sensor and the mold, or the resin-infused preform.

26. A system for manufacturing a composite article, comprising:
a mold for receiving a fiber preform;
a vacuum bag for applying pressure to the fiber preform during a resin infusion process to facilitate infusion of at least one resin into the fiber preform;
an electromagnetic sensor coupled to the vacuum bag and configured to measure a distance between the electromagnetic sensor and the mold;
an ultrasonic transmitter coupled to the mold and configured to deliver an acoustic wave to the resin-infused fiber preform;
an ultrasonic receiver coupled to the vacuum bag and configured to receive the acoustic wave propagated through the resin-infused fiber preform; and
a processor configured to:
estimate at least one parameter from the measured distance,
use the received acoustic wave to determine an extent to which the at least one resin has infused into the resin-infused fiber preform, and
control at least one operating parameter of the composite cure cycle based upon the at least one parameter.

27. The system of claim 26, wherein the at least one operating parameter of the curing cycle comprises a temperature of the composite cure cycle, or an applied pressure to the composite, or combinations thereof.
